(19) United States
(12) Patent Application Publication
(10) Pub. No.: US 2013/0217581 A1
(43) Pub. Date: Aug. 22, 2013

(54) OXIDE SUPERCONDUCTIVITY WIRE MATERIAL AND METHOD OF MANUFACTURING THEREOF

(71) Applicants: Masateru Yoshizumi, Kanagawa (JP); Koichi Nakaoka, Tokyo (JP); Yasuo Takahashi, Kanagawa (JP); Teruo Izumi, Tokyo (JP); Yuh Shiohara, Kanagawa (JP); Yuji Aoki, Tokyo (JP); Katsuhisa Kanbayashi, Kanagawa (JP)

(72) Inventors: Masateru Yoshizumi, Kanagawa (JP); Koichi Nakaoka, Tokyo (JP); Yasuo Takahashi, Kanagawa (JP); Teruo Izumi, Tokyo (JP); Yuh Shiohara, Kanagawa (JP); Yuji Aoki, Tokyo (JP); Katsuhisa Kanbayashi, Kanagawa (JP)

(21) Appl. No.: 13/881,818

(22) PCT Filed: Oct. 26, 2011
(86) PCT No.: PCT/JP2011/005988

§ 371 Date: Apr. 26, 2013

(30) Foreign Application Priority Data
Oct. 27, 2010 (JP) 2010-241271

(51) Int. Cl. H01B 12/06

(52) U.S. Cl. CPC H01B 12/06
USPC 505/230; 505/434; 427/62; 428/384

(57) ABSTRACT

Provided is an oxide superconducting wire material, wherein pinning of magnetic flux, under an environment in which magnetic field is applied, can be conducted efficiently towards any magnetic-field applying angle direction, to secure a high superconductive property. The oxide superconducting wire material (100) is provided with a metal substrate (110), an intermediate layer (120) formed upon the metal substrate (110), and a REBaCuO-system superconductive layer (140) formed upon the intermediate layer (120). RE comprises one or more elements selected from Y, Nd, Sm, Eu, Gd, and Ho. Oxide particles including Zr are distributed within the superconductive layer (140) as magnetic-flux pinning points (145), and the mole ratio (y) of Ba included within the superconductive layer (140) is, when the mole ratio of Zr is assumed to be x, within a range of (1.2+ax)≦y≦(1.8+ax), wherein 0.5≦a≦2.

### TECHNICAL FIELD

The present invention relates to an oxide superconducting wire material which is useful for superconductivity application devices such as a superconducting magnet, a superconducting cable, a current limiter, a power generator, a motor, and a transformer, and also relates to a method of manufacturing the oxide superconducting wire material. In particular, the present invention relates to an oxide superconducting wire material that can be utilized in superconductivity application devices that are used under a magnetic field of a superconducting magnet or the like, and a method of manufacturing the oxide superconducting wire material.

### BACKGROUND ART

The critical temperature (Tc) of an oxide superconductor is higher than a conventional metallic superconductor such as Nb₃Sn or Nb₃Al, and therefore superconductivity application devices such as a power-transmission cable, a transformer and a motor can be operated at the temperature of liquid nitrogen. Consequently, vigorous research is being conducted regarding forming oxide superconductors into a wire material.

In order to apply oxide superconductors to the above-mentioned field, it is necessary to produce a long wire material having a high critical current density (Jc) and a high critical current value (Ic). On the other hand, in order to obtain a long wire material, from the viewpoints of strength and flexibility, it is necessary to form an oxide superconductor on a metal substrate. Also, to enable use of the oxide superconductors at a practical level equivalent to that of conventional metallic superconductors, an Ic value of about 500 A/cm-width (77K, in the self magnetic field) is required.

Among oxide superconductors, an REBa₂Cu₃O_{z} (hereinafter, referred to as “REBCO” or simply “RE-based,” where z=6.2 to 7, and RE represents at least one or more kinds of element selected from the group consisting of Y, Nd, Sm, Eu, Gd and Ho) oxide superconductor has excellent magnetic field characteristics and causes little attenuation of the conducting current in a high magnetic field region. Hence wire material formed using the REBCO oxide superconductor is promising as a next-generation superconducting material.

An MOD (metal organic deposition) method is known as a method of manufacturing an oxide superconducting wire material (hereunder, referred to as “superconducting wire material”) having the aforementioned REBCO oxide superconductor.

According to the MOD method, first, a tape-shaped substrate on which an oxide intermediate layer is formed is immersed in a superconducting raw material solution (solution produced by dissolving an organometallic salt in an organic solvent), and after lifting the substrate out from the superconducting raw material solution, a superconducting film is deposited on the surface of the substrate. Thereafter, an oxide superconductor is formed by performing preliminary calcination and main calcination. Since the MOD method can form an oxide superconductor continuously on a long substrate even in a non-vacuum, the MOD method is attracting attention because, in comparison to gaseous phase methods such as the PLD (pulsed laser deposition) method and the CVD (chemical vapor deposition) method, the process is simple and it is possible to lower the manufacturing cost.

With respect to the MOD method, a TFA-MOD (trifluoro acetate metal organic deposition) method is known that uses a fluorine-containing organic acid salt (for example, TFA salt) as the starting material and performs heat treatment under control of a water vapor partial pressure in a water vapor atmosphere to form a superconductor through the decomposition of fluoride.

When using a superconducting wire material manufactured in this mariner under an applied magnetic field environment such as in a superconducting magnet, it is desirable for the superconducting wire material to have superconducting properties (critical current density Jc [MA/cm²], critical current Ic [A/cm-width]) of a high level for all magnetic field application angles.

For example, when forming a solenoid coil by means of superconducting wire material, because a magnetic field is applied at an angle at which Jc decreases with respect to the substrate surface (superconducting surface) at both ends of the coil, the coil is designed in accordance with the value of the magnetic field application angle dependency of JC (Jc_{,min}). This constitutes a significant problem with respect to application to electric power equipment such as a superconducting transformer, a superconducting magnetic energy storage (SMES), or a superconducting flywheel energy storage that is used under a high magnetic field.

Further, with respect to a superconductor of a superconducting wire material, the density of quantized magnetic flux that penetrates into the superconductor increases as the applied magnetic field increases, and Jc decreases as a result of the quantized magnetic flux moving and the superconducting state breaking down.

In addition, a superconductor has an intrinsic characteristic that, due to the crystal structure, Jc when a magnetic field is applied in the c-axis direction is lower than Jc when a magnetic field is applied in the a-axis direction.

Therefore, applicants constituting the present application previously filed an application regarding a method that, with respect to the TFA-MOD method, addresses the above described problems by introducing nano-sized three-dimensional magnetic flux pinning points that are effective for all magnetic field directions into the superconductor to inhibit the movement of quantized magnetic flux inside the superconductor (see Patent Literature (hereinafter, abbreviated as PTL) 1).

According to PTL 1, an organometallic salt of Zr or the like composed of an element that does not react with a superconductor is added to a superconducting raw material solution that is used when forming a preliminary calcination film in the TFA-MOD method. Subsequently, in the course of a reaction heat treatment in a main calcination step, the organometallic salt is reacted with Ba included in the superconductor, and microparticles of BaZrO₃ (BZO) that is a non-superconducting substance are uniformly distributed as magnetic flux pinning points in a superconducting thin film.

### CITATION LIST

### Patent Literature

### PTL1

### Japanese Patent Application Laid-Open No. 2009-164010

### SUMMARY OF INVENTION

### Technical Problem

According to PTL 1, the magnetic field application angle dependency (Jc_{,min}/Jc_{,max}) of Jc in a superconductive layer is improved by reacting an organometallic salt such as Zr salt with Ba to form magnetic flux pinning points in the superconductive layer.

Based on this, it is desirable to provide a superconducting wire material that has a superconductive layer in which the magnetic field application angle dependency (Jc_{,min}/Jc_{,max}) of Jc is improved to a still further degree compared to the superconducting wire material disclosed in PTL 1 and that can be favorably used even in a high magnetic field.

Hence, it is conceivable to further improve the magnetic field application angle dependency of Jc (Jc_{,min}/Jc_{,max}) by further adding an organometallic salt such as Zr salt to a superconducting raw material solution to increase the pinning points in the superconductive layer.

However, it is found that when the larger amount of an organometallic salt such as Zr is added to a superconducting raw material solution, a degradation occurs with respect to the superconducting properties (Jc, Ic) in the superconductive layer that is formed.

With respect to the cause of this problem, the inventors of the present invention reasoned that reaction of the added organometallic salt such as Zr salt with Ba decreases the mole ratio of the Ba that is required for forming a REBCO-based superconductor, and thus decreases the superconductor volume fraction in a superconducting thin film that serves as a superconductive layer. It is considered that, as a result, Ic of the finished superconductor does not obtain the desired superconducting property and decreases.

An object of the present invention is to provide an oxide superconducting wire material that can effectively pin magnetic flux in all magnetic field application angle directions and can secure superconducting properties of a high level under an environment in which a magnetic field is applied, as well as a method of manufacturing the oxide superconducting wire material.

### Solution to Problem

An oxide superconducting wire material reflecting one aspect of the present invention includes: a substrate, an intermediate layer formed upon the substrate, an REBa_{y}Cu₃O_{z}-based superconductive layer formed upon the intermediate layer, and a stabilization layer formed upon the superconductive layer, the RE including one or more kinds of elements selected from Y, Nd, Sm, Eu, Gd and Ho, in which oxide particles including at least one additional element among Zr, Sn, Ce, Ti, Hf, and Nb are distributed as magnetic flux pinning points in the superconductive layer; and when a mole ratio of the additional element is assumed to be “x”, a mole ratio y of the Ba included in the superconductive layer is in a range of 1.2+ax≦y≦1.8+ax, where 0.5≦a≦2.

A method of manufacturing an oxide superconducting wire material reflecting one aspect of the present invention has an REBa_{y}Cu₃O_{z}-based superconductive layer in which oxide particles including an additional element are distributed as magnetic flux pinning points and which is formed by coating a superconducting raw material solution on an intermediate layer formed upon a substrate, and thereafter performing a heat treatment, in which the superconducting raw material solution includes: RE including one or more kinds of elements selected from Y, Nd, Sm, Eu, Gd and Ho; Ba; Cu; and at least one of the additional elements among Zr, Sn, Ce, Ti, Hf, and Nb; and when a mole ratio of the additional element included in the superconducting raw material solution is assumed to be “x”, a mole ratio y of the Ba included in the superconducting raw material solution is in a range of 1.2+ax≦y≦1.8+ax, where 0.5≦a≦2.

### Advantageous Effects of Invention

According to the present invention, under an environment in which a magnetic field is applied, it is possible to effectively pin magnetic flux with respect to all magnetic field application angle directions and secure superconducting properties of a high level.

### BRIEF DESCRIPTION OF DRAWINGS

FIG. 1 illustrates the relationship between the ratio of Ba and superconducting properties (Jc, Ic) in a fixed-ratio composition of an RE-based superconductor;

FIG. 2 illustrates the magnetic field application angle dependency of a superconductive layer with respect to an added amount of Zr at 77K and 1 T;

FIG. 3 illustrates the magnetic field application angle dependency with respect to an added amount of Zr;

FIG. 4 is a schematic cross-sectional view illustrating the structure of superconducting wire material according to one embodiment of the present invention;

FIG. 5 illustrates a layer structure of another example of superconducting wire material according to one embodiment of the present invention;

FIGS. 6A and 6B illustrate a TEM image of a cross section perpendicular to a superconductive layer of Example 1 that was manufactured according to the present invention, and a material mapping image of the same cross section;

FIGS. 7A and 7B illustrate a TEM image of a cross section perpendicular to a superconductive layer of Example 2 that was manufactured according to the present invention, and a material mapping image of the same cross section; and

FIGS. 8A and 8B illustrate a TEM image of a cross section perpendicular to a superconductive layer of Example 3 that is manufactured according to the present invention, and a material mapping image of the same cross section.

### DESCRIPTION OF EMBODIMENTS

The inventors of the present invention conducted detailed studies regarding the conventional method of manufacturing superconducting wire material using the TFA-MOD method (see PTL 1).

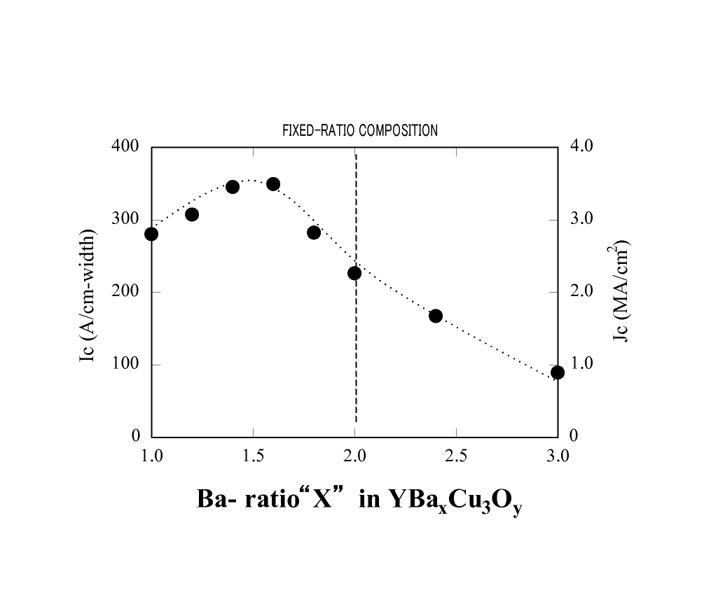

According to the TFA-MOD method, as shown in FIG. 1, the highest Jc is exhibited in a superconducting thin film manufactured using a superconducting raw material solution having a mole ratio of Y:Ba:Cu=1:1.5:3 in which the Ba component is reduced by approximately 0.5 from 2 that is the Ba component used in the case of the stoichiometric composition of the RE-based superconductor (REBCO) (mole ratio is Y:Ba:Cu=1:2:3).

It is found that when it is attempted to improve the magnetic field characteristics by further adding an organometallic salt such as Zr salt to this superconducting raw material solution and uniformly distributing magnetic flux pinning points constituted by oxide particles including the Zr salt or the like in a superconductor, the superconducting properties (Jc, Ic) in the superconductor that is formed are degraded.

With respect to the cause of this problem, the inventors of the present invention reasoned that because the added organometallic salt such as Zr salt reacts with Ba, the mole ratio of the Ba that is required for forming a REBCO-based superconductor decreases, and the superconductor volume fraction in a thin film decreases, and as a result, the Ic of the finished superconductor decreases without the desired superconducting properties being obtained.

Therefore, the inventors conceived of the idea of maintaining the Jc properties in the self magnetic field in the RE-based superconductor (YBCO) and also improving the in-field properties by not just merely adding and distributing an organometallic salt such as Zr salt in a superconductor but compensating beforehand for the shortfall in the amount of Ba required for RE-based superconductor (YBCO) formation as the added amount of organometallic salt increases, to thereby arrive at the present invention.

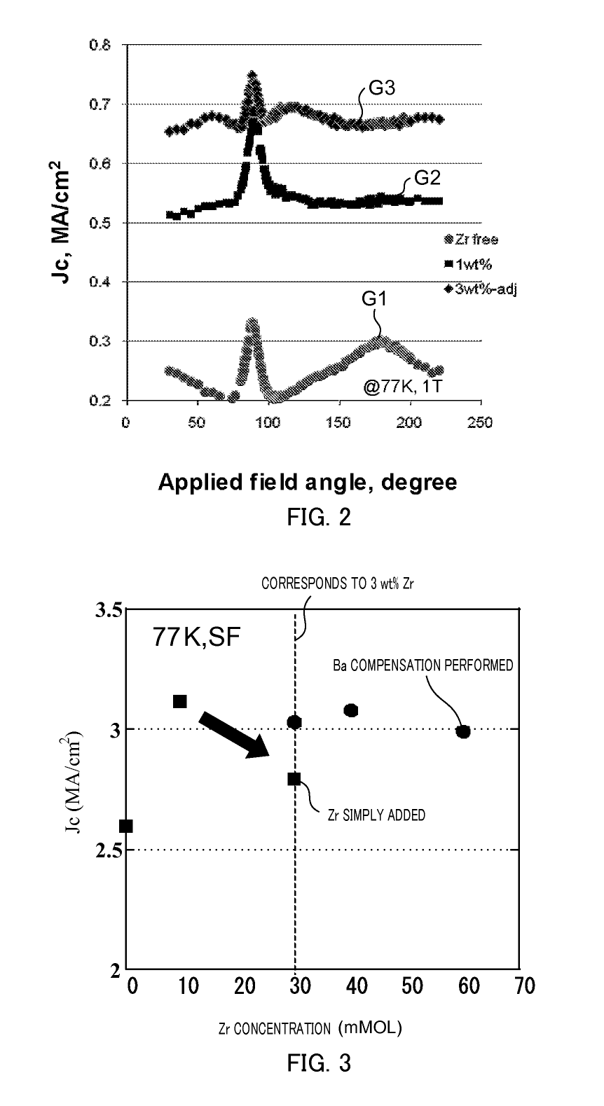

FIG. 2 illustrates the magnetic field application angle dependency of a superconductor with respect to an added amount of Zr at 77K, 1 T. In FIG. 2, reference symbol G1 denotes a state in which Zr is not added, reference symbol G2 denotes a state in which Zr is added in an amount of 1 wt %, and reference symbol G3 denotes a state in which Zr is added in an amount of 3 wt % and compensation is performed with respect to the amount of Ba. FIG. 3 illustrates the relationship between the added amount of 3 wt % of Zr and compensation of the Ba amount, in which “” represents Je in a case where the Zr concentration in the superconducting raw material solution is made a predetermined concentration and compensation is performed with respect to the amount of Ba, and “▪” represents Jc in a case where Zr is merely added to the superconducting raw material solution.

As indicated by G1 and G2 in FIG. 2, Jc increases when Zr salt in an amount of 1 wt % is added as an organometallic salt composed of an element that does not react with a superconductor. However, as shown in FIG. 3, when the concentration of Zr is merely increased from 10 mMOL to 30 mMOL, Jc decreases as indicated by “▪” on the Zr concentration of 30 mMOL.

As shown in FIG. 3, together with using a Zr concentration of 30 mMOL corresponding to the added amount of 3 wt % of Zr, the Ba amount in the superconducting raw material solution is supplemented and compensated for beforehand, that is, Ba of an amount that reacts with the Zr is previously added (see “” on Zr concentration of 30 mMOL) to the amount of Ba that satisfies the composition ratio required for superconductor formation in the superconducting raw material solution. As a result, a superconductor that is formed has a magnetic field characteristic that has high Jc [MA/cm²] in a high magnetic field, and the magnetic field application angle dependency of Je in the superconductor is markedly improved (in FIG. 3, Jc [MA/cm²] for “” is higher at all magnetic field application angles compared to “▪”). That is, in the superconductor, magnetic flux can be effectively pinned with respect to all magnetic field application angle directions.

Thus, according to the present invention, artificial pinning particles (magnetic flux pinning points) that are effective oxide particles are formed by adding an additional element to a raw material solution composition RE:Ba:Cu=1:1.5:3 that is used in an ordinary low-Ba composition method in which the fixed-ratio composition of Ba is made less than 2 in the MOD method. The superconducting raw material solution composition at this time is set in consideration of the composition of the artificial pinning particles (Ba:Zr=1:1 in the case of Zr). Note that RE is composed of one or more kinds of element selected from Y, Nd, Sm, Eu, Gd and Ho.

According to the superconducting wire material of the present invention, when an additional element (additional metal) is assumed to be “M”, a ratio with respect to the superconducting raw material solution composition corresponding to a compound composition that additional element M forms is Y:Ba:Cu:M=1:1.5±y±0.3:3:x (x≧0, y≧0) (y=ax, a=0.5 to 2.0).

Additional element M that is applied at this time is at least one of Zr, Sn, Ce, Ti,

Hf, and Nb. Note that it is necessary for an added amount of the additional element to be less than or equal to 30 wt %, and in particular it is desirable that the added amount of the additional element is 1 wt % to 10 wt % with respect to the entire superconductive layer. The reason why an added amount between 1 wt % and 10 wt % is desirable is that, although the larger added amount of an additional element is more effective for improving the in-field properties because a larger amount of magnetic flux can be pinned, if the added amount exceeds 10 wt %, that is, a volume fraction of 30 vol %, an effect that reduces the volume of the superconductor increases and a threshold at which particles can exist individually is also exceeded, and hence the pinning effect fades and the superconducting current is obstructed. Further, when the above described range is exceeded, precipitate agglomerates and obstructs the superconducting current.

The ratio with Ba when additional element M is at least one of Zr, Sn, Ce, Ti, and Hf is Ba:M=1:1.

When additional element M is Zr, the compound that is formed and distributed as magnetic flux pinning points in the superconductor is BaZrO₃. When additional element M is Ti, the compound that is formed and distributed as magnetic flux pinning points in the superconductor is BaTiO₃. When additional element M is Ce, the compound that is formed and distributed as magnetic flux pinning points in the superconductor is BaCeO₃. Further, when additional element M is Sn, the compound that is formed and distributed as magnetic flux pinning points in the superconductor is BaSnO₃. Furthermore, when additional element M is Hf, the compound that is formed and distributed as magnetic flux pinning points in the superconductor is BaHfO₃. Note that the compounds that serve as the magnetic flux pinning points are uniformly distributed in the superconductor.

In addition, the ratio with Ba when additional element M is Nb is Ba:M=1:0.5 to 2, and a compound that is formed and distributed as magnetic flux pinning points in the superconductor is YNbBa₂O₆ or BaNb₂O₆ or the like. Note that the compounds that serve as the magnetic flux pinning points are uniformly distributed in the superconductor.

In the superconducting wire material in which magnetic flux pinning points are formed in a superconductive layer (superconductor), when the mole ratio of the additional element is assumed to be “x”, the mole ratio y of Ba included in the superconductive layer is in the range 1.2+ax≦y≦1.8+ax, where 0.5≦a≦2.

The present invention improves the TFA-MOD method that is widely utilized for formation of superconducting next-generation wire material. According to the present invention, when non-superconducting nanoparticles that are an additional element such as Zr used to improve in-field properties are introduced into a superconductive layer, the Ba composition of the superconductor overall is controlled in accordance with the composition of the material of the non-superconducting nanoparticles to thereby obtain enhanced properties. That is, the amount of Ba included in a superconductor is set as an amount obtained by adding an amount of Ba that reacts with additional element M to a prescribed amount of Ba that satisfies a target mixture ratio for forming the superconductor. In other words, the amount of Ba included in a superconductive layer is selected so that the amount of Ba which does not react with additional element M is an amount that satisfies the target mixture ratio that is RE:Ba:Cu=1:y:3.

For example, in a superconducting wire material including Y_{0.77}Gd_{0.23}Ba_{1.5+z},Cu₃Oₓ+Zr pins, Ba compensation is performed by adding Ba amount z that reacts with the Zr to a prescribed amount of Ba that satisfies the target mixture ratio (RE:Ba:Cu=1:1.5:3) for forming the superconductor. It is thereby possible to add a high concentration of Zr to increase the magnetic flux pinning points and thereby improve the in-field properties without lowering the Ic. Thus, as a superconducting wire material, a composition can be achieved with which Icₘᵢₙ=30 A/cm-w (77K @ 3 T) at a superconducting film thickness of 2 μm or less can be anticipated.

Hereunder, an embodiment of the present invention is described in detail with reference to the drawings.

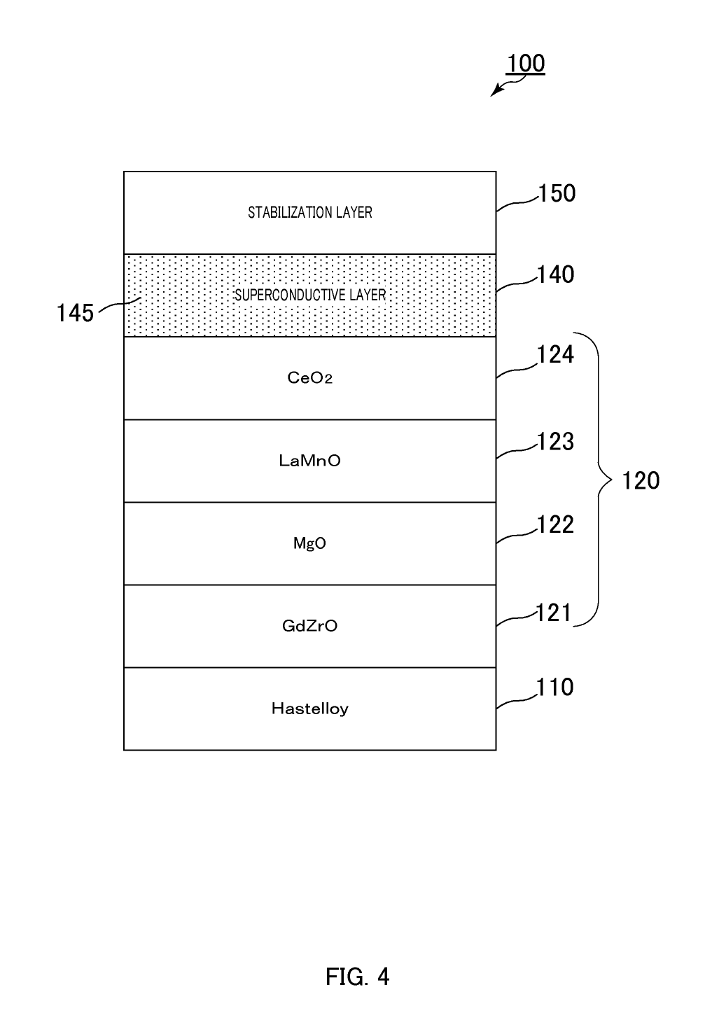

FIG. 4 is a schematic cross-sectional view illustrating the structure of superconducting wire material according to one embodiment of the present invention, which shows a cross section that is perpendicular to an axial direction of a tape-shaped superconducting wire material.

Superconducting wire material 100 is a tape shape, and is formed by laminating intermediate layer 120, tape-shaped oxide superconductive layer (hereunder, referred to as “superconductive layer”) 140, and stabilization layer 150 in that order on tape-shaped metal substrate 110. In this case, intermediate layer 120 includes first intermediate layer 121, second intermediate layer 122, third intermediate layer 123 and fourth intermediate layer 124.

Tape-shaped metal substrate 110 is, for example, nickel (Ni), a nickel alloy, stainless steel or silver (Ag). In this case, metal substrate 110 is a metal substrate with non-oriented crystal grains and high heat-resistance strength, and is a nonmagnetic alloy with a Vickers hardness (Hv)=150 or more of a cubic crystal system that is typified by a material such as an Ni—Cr based alloy (specifically, Ni—Cr—Fe—Mo based Hastelloy (registered trademark) B, C, X or the like), a W—Mo based alloy, an Fe—Cr based alloy (for example, austenitic stainless steel), and an Fe—Ni based alloy (for example, a non-magnetic composition based alloy). The thickness of metal substrate 110 is, for example, less than or equal to 0.1 mm.

First intermediate layer 121 is an intermediate layer of non-oriented crystal grains formed by depositing Gd₂Zr₂O₇ (GZO) or yttrium oxide (Y₂O₃) or the like by a sputtering method on tape-shaped metal substrate 110. Second intermediate layer 122 that is constituted by magnesium oxide (MgO) with an all-axes crystal-grain-orientation formed by the IBAD method is deposited on first intermediate layer 121. Third intermediate layer 123 constituted by LaMnO₃ is deposited by a sputtering method on second intermediate layer 122, and fourth inteiiiiediate layer 124 constituted by a cap layer composed of CeO₂ is formed thereon by a PLD method or a sputtering method.

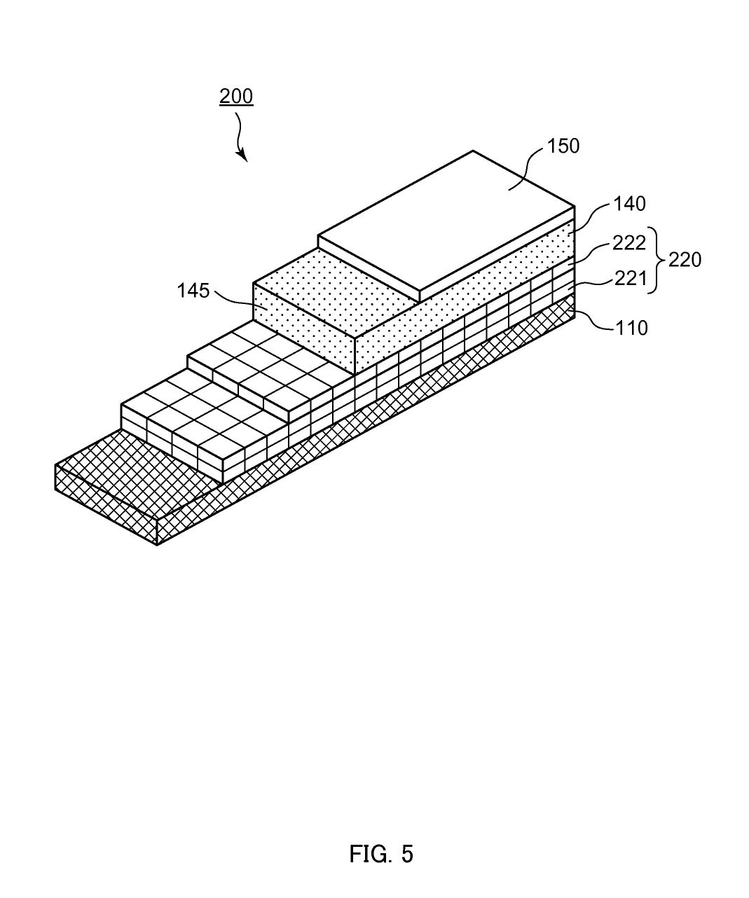

Further, superconducting wire material 200 illustrated in FIG. 5 may be adopted as another superconducting wire material in which the intermediate layer is different relative to the configuration of superconducting wire material 100. In superconducting wire material 200 illustrated in FIG. 5, first intermediate layer 221 is an intermediate layer of all axial orientations formed by depositing Gd₂Zr₂O₇ (GZO) or yttria-stabilized zirconia (YSZ) or the like on tape-shaped metal substrate 110 by the IBAD method. Note that the thickness of first intermediate layer 221 is approximately 1000 nm. CeO₂ is subjected to vapor deposition by a sputtering method onto first intermediate layer 221 of all axial orientations to form second intermediate layer 222 as a cap layer of all axial orientations. Note that the thickness of cap layer (second intermediate layer) 222 is approximately 1000 nm. Further, when cap layer (second intermediate layer) 222 is formed as a Ce—Gd—O film obtained by adding Gd to a CeO₂ film, to obtain favorable orientation when a YBCO superconductive layer is formed as superconductive layer 140, it is preferable that the added amount of Gd in the film is less than or equal to 50 at %. Superconductive layer 140 is formed on cap layer (second intermediate layer) 222. In superconducting wire material 200, intermediate layer 220 is formed by first intermediate layer 221 and cap layer (second intermediate layer) 222.

Stabilization layer 150 that is made of a precious metal such as silver, gold, or platinum or a low-resistance metal that is an alloy of the aforementioned metals is provided on superconductive layer 140. Note that by forming stabilization layer 150 directly over superconductive layer 140, stabilization layer 150 prevents a degradation in the performance of superconductive layer 140 due to a reaction caused by direct contact between superconductive layer 140 and a material other than a precious metal such as gold or silver or an alloy of these metals, and also prevents a breakage or a performance degradation due to heat generation, by dispersing heat that is generated by a fault current or passage of an alternating current. In this case, the thickness of stabilization layer 150 is 10 to 30 μm.

Superconductive layer 140 is an all-axial orientation REBCO layer, that is, a layer of a high-temperature superconducting thin film of an REBa_{y}Cu₃O_{z}-based (where RE represents one or more kinds of element selected from Y, Nd, Sm, Eu, Gd and Ho, y≦2, and z=6.2 to 7). In this case, superconductive layer 140 is an yttrium-based oxide superconductor (RE123).

Further, oxide particles that are compounds having a particle diameter of 50 nm or less, more preferably, 10 nm or less, that include at least one additional element among Zr, Sn, Ce, Ti, Hf, and Nb are uniformly distributed as magnetic flux pinning points (artificial pinning particles) 145 in superconductive layer 140. The reason for this is that it is desirable for the particle diameter of the magnetic flux pinning points to be within the above described range because a greater effect is exerted when the particle diameter is close to the size of magnetic flux lines.

It is desirable that number n of oxide particles included in superconductive layer 140 is within the range 1.0×10³≦n≦1.0×10⁷ per 1 μm³. Although the amount of magnetic flux that can be pinned increases effectively as the number of particles increases, if the aforementioned range is exceeded, the superconducting current is obstructed because an effect that reduces the volume of the superconductor increases and ultimately degrades the superconducting properties. For example, when number n of oxide particles present in superconductive layer 140 is 10×10⁷ per 1 μm³ or more, even if the particle diameter of the oxide particles is 5 nm, 60% is exceeded in terms of the volume fraction and consequently the superconducting properties are degraded.

RE-based superconducting wire material 100 that uses this kind of superconductive layer 140 is manufactured by performing a preliminary calcination heat treatment after coating a superconducting raw material solution on substrate 110 through intermediate layer 120, and thereafter forming REBa_{y}Cu₃O_{z}-based superconductive layer 140 by performing a main calcination heat treatment.

A superconducting raw material solution used in this method includes RE (where RE represents one or more kinds of element selected from Y, Nd, Sm, Eu, Gd and Ho), an organometallic complex solution including Ba and Cu, and an organometallic complex solution including at least one additional element among Zr, Sn, Ce, Ti, Hf, and Nb having a high affinity for Ba.

Using the aforementioned substances, superconducting wire material 100 can be produced by, when a mole ratio of the additional element is assumed to be “x”, making mole ratio y of Ba included in the superconducting raw material solution satisfy the range 1.2+ax≦y≦1.8+ax, where 0.5≦a≦2, and furthermore, causing oxide particles of a particle diameter of 50 nm or less, preferably, a particle diameter of 10 nm or less that include Zr, Ce, Sn, Hf, Nb or Ti to be distributed as magnetic flux pinning points 145 in the superconductor.

Preferably, mixed solutions of the following (a) to (d) are used as the superconducting raw material solution used in this case. (a) Organometallic complex solution including RE: solution including any one or more kinds of substance among the group consisting of trifluoroacetate, naphthenate, octylate, levulinate, neodecanoate, and acetate that include RE. A trifluoroacetate solution including RE is particularly preferable. (b) Organometallic complex solution including Ba: solution of trifluoroacetate including Ba. (c) Organometallic complex solution including Cu: solution including any one or more kinds of substance among the group consisting of naphthenate, octylate, levulinate, neodecanoate, and acetate that include Cu. (d) Organometallic complex solution including a metal having a large affinity for Ba: solution including any one or more kinds of substance among the group consisting of trifluoroacetate, naphthenate, octylate, levulinate, neodecanoate, and acetate that include at least one or more kinds of metal selected from the group consisting of Zr, Sn, Ce, Ti, Hf, and Nb.

Preferably, superconductive layer 140 is formed on cap layer (fourth intermediate layer) 124 by performing preliminary calcination heat treatment with a temperature range of 400 to 500° C. in an atmosphere having a water vapor partial pressure of 3 to 76 Torr and an oxygen partial pressure of 300 to 760 Torr, and thereafter performing main calcination heat treatment with a temperature range of 700 to 800° C. in an atmosphere having a water vapor partial pressure of 30 to 600 Torr and an oxygen partial pressure of 0.05 to 1 Torr.

In the above RE-based superconductive layer 140 and the manufacturing method thereof, the mole ratio of Ba in the superconductive layer is preferably obtained by adding an amount that reacts with an additional element such as Zr that is added to form magnetic flux pinning points 145, to the amount satisfying the ratio RE:Ba:Cu=1:1.5:3. Note that by making the mole ratio of Ba smaller than the standard mole ratio (ratio that satisfies RE:Ba:Cu=1:2:3), segregation of Ba is suppressed, and precipitation of Ba-based impurities at the crystal grain boundary is suppressed. As a result, the occurrence of cracks is suppressed, and the electric coupling between the crystal grains improves to increase Jc which is defined by the conducting current.

Further, although the particle diameter of oxide particles including at least one of Zr, Sn, Ce, Ti, and Hf that are distributed as magnetic flux pinning points 145 that are artificially introduced into superconductive layer 140 is made less than or equal to 50 nm, in particular, it is desirable for the particle diameter to be less than or equal to 10 nm.

Note that it is necessary for the added amount of Zr that is added in order to form magnetic flux pinning points 145 that are artificially introduced, to be less than or equal to 30 wt % with respect to the metal concentration. An added amount of 1 to 10 wt % is particularly preferable. The reason is that, if the added amount of Zr is less than 1 wt %, the density of the oxide particles will be insufficient, and thus an adequate pinning force will not be obtained in a high magnetic field. Further, if the added amount of Zr exceeds the above described range, since an effect that reduces the volume of the superconductor increases and a threshold at which the particles can exist individually will be exceeded, the pinning effect will fade and the superconducting current will be obstructed. Further, when the above described range is exceeded, precipitate agglomerates and obstructs the superconducting current.

Superconductive layer 140 is formed by the TFA-MOD method. A technique that mixes naphthenate including Zr or the like that has a high affinity for Ba in a solution including TFA is adopted as the technique for introducing magnetic flux pinning points 145 into the RE-based superconductive layer produced according to the TFA-MOD method.

Further, along with the introduced amount, that is, the additional element such as Zr, by adjusting the amount of Ba in the superconducting raw material solution by adding an amount of Ba that reacts with the additional element, Zr combines with Ba to form BaZrO₃ that serves as pinning points (artificial pinning particles) while maintaining the composition of the superconductive layer (RE:Ba:Cu=1:1.5:3). By distributing BaZrO₃ inside the grains that form the superconductive layer, a degradation in Jc due to grain boundary segregation does not occur, and the grain boundary characteristic is improved.

In addition, BaZrO₃ particles formed in the superconductive layer are nano-sized and are distributed with nano-sized intervals therebetween in not just the film surface direction but also the film thickness direction, and these particles effectively pin the magnetic flux. It is thus possible to markedly improve the anisotropy of Jc with respect to the magnetic field application angles. Further, control of the size, density and distribution of BaZrO₃ can be performed not just by controlling the introduced amount of naphthenate including Zr or the like, but also by controlling an oxygen partial pressure, a water vapor partial pressure, and a calcination temperature at the time of the preliminary calcination heat treatment and the main calcination heat (crystallization heat) treatment, and effective introduction of magnetic flux pinning points 145 is enabled by optimizing these conditions.

Furthermore, in an RE-based superconductive layer in which the Ba concentration is reduced in superconducting wire material 100, magnetic flux pinning points 145 containing Zr can be finely distributed in an artificial manner in the superconductive layer. Consequently, in addition to having magnetic field characteristics such that the magnetic field application angle dependency of Jc (Jc_{,min}/Jc_{,max}) is small and a high Jc is obtained in a high magnetic field, the magnetic field application angle dependency of Jc (Jc_{,min}/Jc_{,max}) can also be markedly improved. Hence, in addition to the self magnetic field, in a magnetic field also, superconducting properties (critical current density Jc [MA/cm²] and critical current Ic [A/cm-width]) of a high level can be secured as a result of the magnetic flux being effectively pinned in all magnetic field application angle directions and an isotropic Jc characteristic being obtained.

### EXAMPLE 1

Superconducting wire material was manufactured using the above described method of manufacturing superconducting wire material 100. Specifically, a composite substrate was used in which, in the following order, first intermediate layer 121 (see FIG. 4) composed of Gd₂Zr₂O₇ was formed by the sputtering method, second intermediate layer 122 (see FIG. 4) composed of MgO was formed by the IBAD method, third intermediate layer 123 (see FIG. 4) composed of LaMnO₃ was formed by the sputtering method, and cap layer (fourth intermediate layer) 124 (see FIG. 4) composed of CeO₂ was formed by the PLD method on a Hastelloy (registered trademark) tape as a metal substrate. In this case, Δφ of cap layer 124 was 4.5 degrees.

On the other hand, while mixing Y-TFA salt, Gd-TFA salt, Ba-TFA salt and naphthenate of Cu in an organic solvent, Zr-containing naphthenate that adopted Zr as an additional element (additional metal) was added at a metal weight ratio of 1% (1 wt %) to this mixed solution and blended therewith. A superconducting raw material solution was prepared so that the mole ratio of Y:Gd:Ba:Cu was maintained at 0.77:0.23:1.5:3 by adding an amount of Ba for reacting with Zr upon the addition of Zr.

The superconducting raw material solution was coated onto the cap layer of the composite substrate, and thereafter preliminary calcination heat treatment was performed. The preliminary calcination heat treatment was performed by heating to a maximum heating temperature (Tmax) of 500° C. in an oxygen gas atmosphere having a water vapor partial pressure of 16 Torr, and thereafter cooling the furnace. After the preliminary calcination heat treatment, main calcination heat treatment (crystallization heat treatment) was performed, and a superconducting film (superconductive layer) was formed on the composite substrate. The main calcination heat treatment was performed by maintaining a temperature of 760° C. in an argon gas atmosphere having a water vapor partial pressure of 76 Ton and an oxygen partial pressure of 0.23 Torr, and thereafter cooling the furnace.

By performing this method, a tape-shaped RE-based (YGdBCO+BZO) superconducting wire material was manufactured that had a film thickness of 0.8 μm and a superconductive layer in which oxide particles BaZrO₃ including Zr were uniformly distributed as magnetic flux pinning points. At this time, the particle diameter of the oxide particles was approximately 30 nm, and the number of oxide particles in the superconductive layer was 7.5×10³ per 1 μm³. Further, the interval between oxide particles within the superconductive layer was approximately 125 nm.

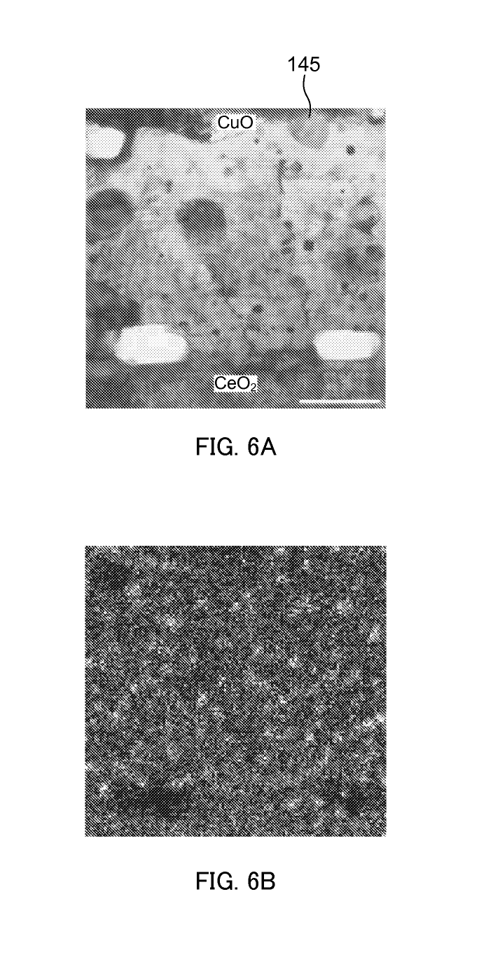

FIG. 6A illustrates a TEM image of a cross section perpendicular to the superconductive layer of Example 1, and FIG. 6B illustrates an element mapping image of the same cross section. In FIG. 6A, BaZrO₃ in the superconductive layer is shown as magnetic flux pinning point 145, and in FIG. 6B the BaZrO₃ particles that are magnetic flux pinning points appear as light parts among the dark and light parts. Thus, in the superconductive layer shown in FIGS. 6A and 6B, BaZrO₃ that are oxide particles including Zr are uniformly distributed as magnetic flux pinning points 145. In the superconducting wire material of Example 1, Jc was 3.1 [MA/cm²] (@77K, self magnetic field), and Jc,min was 0.51 [MA/cm²] (@77K, 1 T).

### EXAMPLE 2

A superconducting wire material in which oxide particles including Sn were formed as magnetic flux pinning points in the superconductive layer was manufactured by a similar method to Example 1. In the similar method to Example 1, a superconducting raw material solution was used in which Sn was adopted instead of the additional element (additional metal) Zr, and Sn in an amount of 1 wt % was added to the superconducting raw material solution.

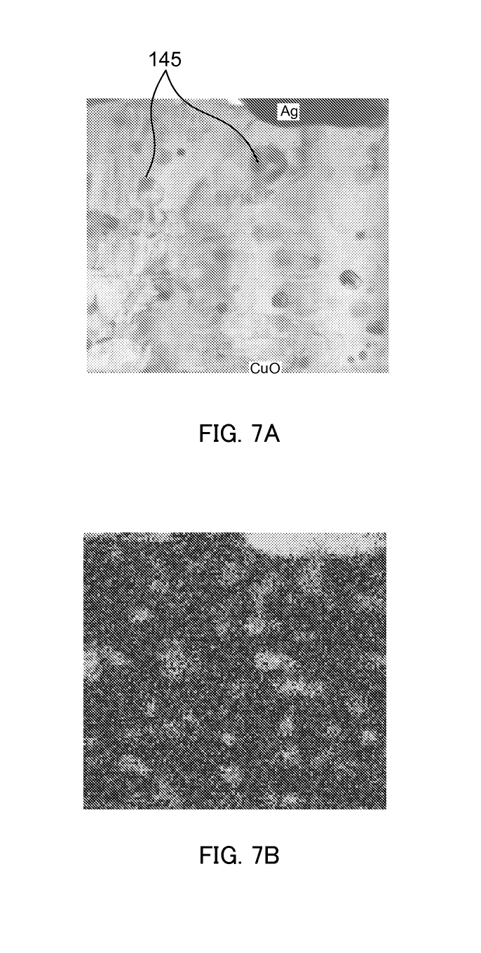

FIG. 7A is a TEM image of a cross section perpendicular to the superconductive layer of Example 2, and FIG. 7B is an element mapping image of the same cross section. Similarly to FIGS. 6A and 6B, FIG. 7A shows magnetic flux pinning points 145 in the superconductive layer, and FIG. 7B shows magnetic flux pinning points that appear as light parts among the dark and light parts. As shown in FIGS. 7A and 7B, BaSnO₃ that are oxide particles including Sn are formed as magnetic flux pinning points 145 in a uniformly distributed manner in the superconductive layer. Note that the particle diameter and number of magnetic flux pinning points 145 was similar to Example 1, and equivalent results to those in Example 1 were obtained for the superconducting wire material of Example 2.

### EXAMPLE 3

A superconducting wire material in which oxide particles including Nb were formed as magnetic flux pinning points in the superconductive layer was manufactured by a similar method to Example 1. In the similar method to Example 1, a superconducting raw material solution was used in which Nb was adopted instead of the additional element (additional metal) Zr, and Nb in an amount of 1 wt % was added to the superconducting raw material solution.

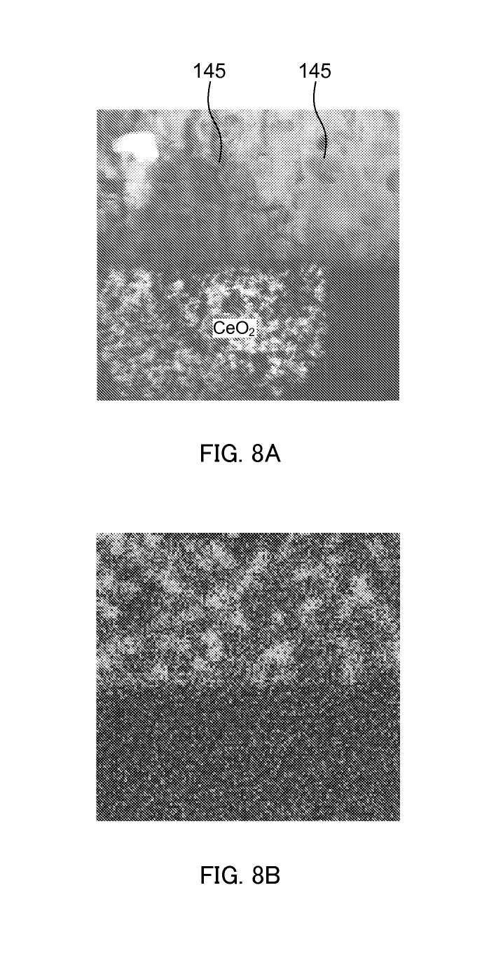

FIG. 8A is a TEM image of a cross section perpendicular to the superconductive layer of Example 3, and FIG. 8B is an element mapping image of the same cross section. Similarly to FIGS. 6A and 6B, FIG. 8A shows magnetic flux pinning points 145 in the superconductive layer, and FIG. 8B shows magnetic flux pinning points that appear as light parts among the dark and light parts. As shown in FIGS. 8A and 8B, YNbBa₂O₆ and BaNb₂O₆ that are oxide particles including Nb were formed as magnetic flux pinning points in a uniformly distributed manner in the superconductive layer. Note that the particle diameter and number of magnetic flux pinning points 145 was similar to Example 1, and equivalent results to those in Example 1 were obtained for the superconducting wire material of Example 3.

### EXAMPLE 4

A superconducting wire material including a superconductive layer in which oxide particles including Zr were formed as magnetic flux pinning points was manufactured using a superconducting raw material solution that was mixed and prepared by a similar manufacturing method to Example 1 except that Zr-containing naphthenate that adopted Zr as an additional element (additional metal) was added in an amount of 3% (3 wt %) in terms of the metal weight ratio, and the amount of Ba reacting with Zr due to the addition of Zr was added to maintain the mole ratio of Y:Gd:Ba:Cu at 0.77:0.23:1.5:3. That is, the superconducting wire material of Example 4 had a superconductive layer in which oxide particles BaZrO₃ including Zr were uniformly distributed as magnetic flux pinning points. In the superconducting wire material of Example 4, Jc was 3.0 [MA/cm²] (@77K, self magnetic field) and Jc,min was 0.66 [MA/cm²] (@77K, 1 T).

### Comparative Example 1

A superconducting wire material was manufactured by a similar manufacturing method to Example 1 except that the additional element (additional metal) Zr was not added. That is, the superconducting wire material that had no magnetic flux pinning points in a superconductive layer was manufactured by coating a superconducting raw material solution in which Y-TFA salt, Gd-TFA salt, Ba-TFA salt and naphthenate of Cu were mixed so that the mole ratio of Y:Gd:Ba:Cu was 0.77:0.23:1.5:3 on a cap layer of a composite substrate that was similar to the composite substrate of Example 1. In the superconducting wire material of Comparative Example 1, Jc was 2.6 [MA/cm²] (@77K, self magnetic field), and Jc,min was 0.20 [MA/cm²] (@77K, 1 T).

### Comparative Example 2

A superconducting wire material was manufactured in a similar manner to the superconducting wire material of Example 1 using a composite substrate of a similar structure to Example 1 and a superconducting raw material solution obtained by simply adding Zr in an amount of 3 wt % to a superconducting raw material solution in which the mole ratio of Y:Gd:Ba:Cu was 0.77:0.23:1.5:3 without performing Ba compensation.

That is, the superconducting wire material was manufactured by coating a superconducting raw material solution to which Zr of a metal weight ratio of 3% (3 wt %) was simply added on a cap layer of a similar composite substrate to Example 1, and performing preliminary calcination heat treatment and main calcination heat treatment. The superconducting wire material had magnetic flux pinning points in the superconductive layer. In the superconducting wire material of Comparative Example 2, Jc was 2.8 [MA/cm²] (@77K, self magnetic field), and Jc,min was 0.40 [MA/cm²] (@77K, 1 T), and Jc was less than 3.0 for example. As a result, desired superconducting properties could not be obtained.

### Comparative Example 3

A similar manufacturing method to Example 4 was employed to manufacture superconducting wire material that included a superconductive layer in which oxide particles including Zr were formed as magnetic flux pinning points using a superconducting raw material solution to which Zr-containing naphthenate that adopted Zr as an additional element (additional metal) in which the particle diameter was approximately 70 nm was added in an amount of 3% (3 wt %) with respect to the metal weight ratio. Jc was less than 3.0 [MA/cm²] (@77K, self magnetic field), and Jc,min was less than 0.50 [MA/cm²] (@77K, 1 T), for example. As a result, desired superconducting properties could not be obtained.

Example 1 as well as Example 2 and Example 3 in which Zr added to the superconducting raw material solution in Example 1 was replaced with Sn and Nb, respectively, will now be compared with Comparative Example 1 in which Zr was not added to the superconducting raw material solution.

As is clear from the results of Examples 1 to 3 and Comparative Example 1, Examples 1 to 3 that are each a tape-shaped RE-based superconducting wire material (REBCO+oxide particles including Zr) according to the present invention exhibit magnetic field characteristics that have higher Jc than Comparative Example 1. Further, as is clear from the results of Example 4 and Comparative Example 2, Example 4 that is a tape-shaped RE-based superconducting wire material (REBCO+oxide particles including Zr) according to the present invention exhibits magnetic field characteristics that have higher Jc than Examples 1 to 3 and Comparative Example 2 as a result of performing Ba compensation together with increasing the amount of the additional element. Furthermore, as is clear from the results of Example 4 and Comparative Example 3, Example 4 that is a tape-shaped RE-based superconducting wire material (RE-based BCO+oxide particles including Zr) according to the present invention exhibits magnetic field characteristics that have higher Jc than Comparative Example 3 because of the particle diameter of the additional element.

The disclosure of Japanese Patent Application No. 2010-241271, filed on Oct. 27, 2010, including the specification, drawings, and abstract, is incorporated herein by reference in its entirety.

### INDUSTRIAL APPLICABILITY

An oxide superconducting wire material according to the present invention is useful as an oxide superconducting wire material which has an effect that, under an environment in which a magnetic field is applied, can effectively pin magnetic flux with respect to all magnetic field application angle directions, and which is used under an environment in which a magnetic field is applied, for example, in a superconducting motor.

### REFERENCE SIGNS LIST

100, 200 Oxide superconducting wire material
110 Metal substrate
120, 220 Intermediate layer
121, 221 First intermediate layer
122, 222 Second intermediate layer
123 Third intermediate layer
124 Fourth intermediate layer
140 Superconductive layer
145 Magnetic-flux pinning point
150 Stabilization layer

1. An oxide superconducting wire material comprising a substrate, an intermediate layer formed upon the substrate, an REBa_{y}Cu₃O_{z}-based superconductive layer formed upon the intermediate layer, and a stabilization layer formed upon the superconductive layer, in which the RE comprises one or more kinds of elements selected from Y, Nd, Sm, Eu, Gd and Ho, wherein
oxide particles including at least one additional element among Zr, Sn, Ce, Ti, Hf, and Nb are distributed as magnetic flux pinning points in the superconductive layer; and
when a mole ratio of the additional element is assumed to be “x”, a mole ratio y of the Ba included in the superconductive layer is in a range of 1.2+ax≦y≦1.8+ax, where 0.5≦a≦2.

2. The oxide superconducting wire material according to claim 1, wherein
a particle diameter of the oxide particles is less than or equal to 50 nm.

3. The oxide superconducting wire material according to claim 1, wherein
a particle diameter of the oxide particles is less than or equal to 10 nm.

4. The oxide superconducting wire material according to claim 1, wherein
a number n of the oxide particles included in the superconductive layer is in a range of 1.0×10³ particles≦n≦1.0×10⁷ particles per 1 μm³.

5. The oxide superconducting wire material according to claim 1, wherein
an added amount of the additional element is less than or equal to 30 wt % relative to the whole of the superconductive layer.

6. The oxide superconducting wire material according to claim 1, wherein
the additional element is Zr, and a value of “a” is 1.

7. A method of manufacturing an oxide superconducting wire material having an REBa_{y}Cu₃O_{z}-based superconductive layer in which oxide particles including an additional element are distributed as magnetic flux pinning points and which is formed by coating a superconducting raw material solution on an intermediate layer formed upon a substrate, and thereafter performing a heat treatment, wherein
the superconducting raw material solution includes: RE comprising one or more kinds of elements selected from Y, Nd, Sm, Eu, Gd and Ho; Ba; Cu; and at least one of the additional elements among Zr, Sn, Ce, Ti, Hf, and Nb; and
when a mole ratio of the additional element included in the superconducting raw material solution is assumed to be “x”, a mole ratio y of the Ba included in the superconducting raw material solution is in a range of 1.2+ax≦y≦1.8+ax, where 0.5≦a≦2.
